(19) United States
(12) Patent Application Publication
(10) Pub. No.: US 2009/0276392 A1
(43) Pub. Date: Nov. 5, 2009

(54) DYNAMIC SEQUENCING DISPLAY PROTOCOLS FOR MEDICAL IMAGING DATA

(76) Inventor: John Yan, Libertyville, IL (US)

Correspondence Address: MCANDREWS HELD & MALLOY, LTD, 500 WEST MADISON STREET, SUITE 3400, CHICAGO, IL, 60661, US

(21) Appl. No.: 12/114,458

(22) Filed: May 2, 2008

(51) Int. Cl. G06N 5/02

(52) U.S. Cl. 706/60

(57) ABSTRACT

Certain embodiments of the present invention provide a method for configuring a medical imaging system, the method comprising: permitting a user to interact with a display protocol, said display protocol further comprising a plurality of rules; allowing said user to select a target rule from said plurality of rules; and facilitating said user to configure a condition for said target rule, wherein said display protocol is capable of a first execution when said condition is satisfied, and wherein the display protocol is capable of a second execution when said condition is not satisfied. In accordance with an embodiment, said condition further comprises at least one of: an entry condition and an exit condition.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to dynamic display configuration in a picture archiving and communication system. In particular, certain embodiments of the present invention relate to user-defined display protocols.

Healthcare environments, such as hospitals or clinics, include clinical information systems, such as hospital information systems (HIS) and radiology information systems (RIS), and storage systems, such as picture archiving and communication systems (PACS) and Mammography systems. Information stored in such systems may include patient medical histories, imaging data, test results, diagnosis information, management information, and/or scheduling information, for example. The information may be centrally stored or across multiple locations. Healthcare practitioners may desire to access patient information or other information at various points in a healthcare workflow. For example, during surgery, medical personnel may access patient information, such as images of a patient's anatomy, which are stored in a medical information system. Alternatively, medical personnel may enter new information, such as history, diagnostic, or treatment information, into a medical information system during the workflow.

A reading, such as a radiology procedure reading, is a process for a healthcare practitioner, such as a radiologist, to view digital images of a patient. A PACS or mammography system may provide one or more medical images for examination by a medical professional. For example, a PACS or mammography system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

Current PACS and mammography systems use general techniques known as “hanging protocols” to format display of images. Hanging, or display protocols present a view of images to a user, such as a radiologist. A user may be able to define the display protocols. For mammography studies and certain other radiology studies, a sequence of display protocol rules may be used. Software on PACS or mammography workstations may allow the user to define display protocol rules through a sequencing algorithm. However, the sequencing algorithm may not dynamically adjust to a given reading, study, or other run-time aspects. Therefore, methods and systems for providing user-defined display protocols are needed.

### BRIEF SUMMARY OF THE INVENTION

Certain embodiments of the present invention provide a method for configuring a medical imaging system, the method including: permitting a user to interact with a display protocol, the display protocol further including a plurality of rules; allowing the user to select a target rule from the plurality of rules; and facilitating the user to configure a condition for the target rule, wherein the display protocol is capable of a first execution when the condition is satisfied, and wherein the display protocol is capable of a second execution when the condition is not satisfied. In accordance with an embodiment, the condition further includes at least one of: an entry condition and an exit condition. In accordance with an embodiment, the condition is capable of being satisfied by a triggering event. In accordance with an embodiment, the user is facilitated to configure the condition using a graphical user interface on a PACS workstation. In accordance with an embodiment, the target rule includes at least one Boolean expression. In accordance with an embodiment, image data is displayed through the application of the display protocol. In accordance with an embodiment, non-image data is displayed through the application of the display protocol.

Certain embodiments of the present invention provide a method for medical imaging, the method including: performing a display protocol, the display protocol further including a sequence of rules; processing a current rule in the sequence of rules; evaluating a condition of the current rule; and selectively branching in the display protocol based on the condition. In accordance with an embodiment, the method further includes displaying image data, wherein a view of the image data is generated through the application of the display protocol. In accordance with an embodiment, the method further includes displaying non-image data through the application of the display protocol. In accordance with an embodiment, the condition further includes at least one of: an entry condition and an exit condition. In accordance with an embodiment, the evaluation of the condition is based on a triggering event. In accordance with an embodiment, the current rule includes at least one Boolean expression.

Certain embodiments of the present invention provide a management system for display protocols in a picture archiving and communication environment, the system including: an electronically stored display protocol, the display protocol further including a sequence of rules; a processing unit for processing a current rule in the sequence of rules, and for evaluating a condition of the current rule; and an execution unit for selectively executing at least one rule in the display protocol based on the condition. In accordance with an embodiment, the condition further includes at least one of: an entry condition and an exit condition. In accordance with an embodiment, the system further includes a display device for displaying image data through the application of the display protocol. In accordance with an embodiment, the system further includes a display device for displaying non-image data through the application of the display protocol.

Certain embodiments of the present invention provide a computer readable storage medium including a set of instructions for a computer, the set of instructions including: a processing routine for processing a display protocol, the display protocol including a current rule in a sequence of rules; an evaluation routine for evaluating a condition of the current rule; and an execution routine for selectively executing at least one rule in the display protocol based on the condition. In accordance with an embodiment, the set of instructions further includes a display routine for displaying through the application of the display protocol, at least one of: image data and non-image data. In accordance with an embodiment, the condition further includes at least one of: an entry condition and an exit condition.

### BRIEF DESCRIPTION OF SEVERAL VIEWS OF THE DRAWINGS

FIG. 1 shows a system for processing medical image data, in accordance with embodiments of the present invention.

FIG. 2 shows a flowchart for a method of processing medical image data, in accordance with embodiments of the present invention.

FIG. 3 shows a flowchart for a method of processing medical image data, in accordance with embodiments of the present invention.

FIG. 4 shows a flowchart for a method of processing medical image data, in accordance with embodiments of the present invention.

FIG. 5 shows a sample screen shot, in accordance with embodiments of the present invention.

FIG. 6 shows a sample screen shot, in accordance with embodiments of the present invention.

FIG. 7 shows a sample screen shot, in accordance with embodiments of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentalities shown in the attached drawings.

### DETAILED DESCRIPTION OF THE INVENTION

The methods of certain embodiments of the present invention may be carried out using the types of computer systems available in the modern healthcare environment. These computer systems are often networked systems having data stores or databases and workstations allowing clinical users to view and otherwise interact with patient data. The components and/or functionality of a given system may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other computing device, such as, for example, a workstation.

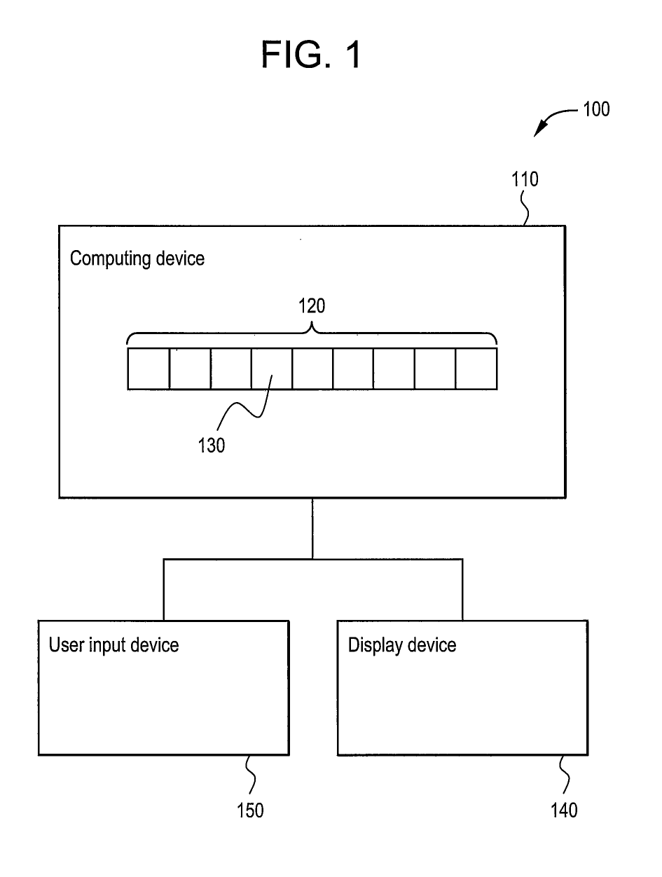

Turning to FIG. 1, a system 100 for processing medical image data is shown, in accordance with embodiments of the present invention. The system 100 includes a computing device 110, a display device 140, a display protocol 120 having a plurality of rules 130, and a user input device 150, for example. The system 100, or variations thereof, may be used to facilitate performance of various methods disclosed herein. The components of the system 100 may be single units, separate units, may be integrated in various forms, or may be implemented in hardware and/or in software.

The computing device 110 may be connected to other devices as part of an electronic network. For example, the computing device 110 may be connected to a database for retrieval of information, an intranet for local communication or the Internet for global communication.

The computing device 110, such as a PACS or mammography workstation, may retrieve or receive image data from a server for display to one or more users. For example, the computing device 110 may retrieve or receive image data representative of a computed radiography image of a patient's chest, and the image data may be displayed on the display device 140 through the application of the display protocol. A radiologist may then examine the image as displayed on the display device 140 for any objects of interest such as, for example, tumors, lesions, etc.

The computing device 110 may also be capable of or configured to retrieve and/or receive one or more display protocols 120 from the server. The computing device 110 may present images according to the display protocol 120.

The computing device 110 may be, or may be part of, a PACS system, or other system that permits electronic medical information and images, such as x-rays, ultrasound, CT, MRI, EBT, MR, or nuclear medicine for example, to be electronically acquired, stored, or transmitted for viewing and operation. The computing device 110 may represent equipment that may be generally associated with PACS, including user input devices 150, communication processing, and storage equipment. The user input device 150 may include a standard keyboard computer mouse, buttons, touch screen, or track ball, for example, and/or any combination thereof. The computing device 110 may display data depicting medical images and/or information about a patient on the display device 140. The computing device 110 may include various functional components or units for performing the methods and systems disclosed herein. For example, the computing device 110 may include a processing unit or an execution unit.

The display protocol 120 may include a set of display rules 130 for presenting, formatting and otherwise organizing images on the display device 140 or the computing device 110. A display rule 130 may provide information for presenting one or more images in a particular temporal and/or spatial layout or sequence. For example, the display protocol 120 may include a set of computer-readable instructions (e.g., display rules 130) that direct the computing device 110 to display a plurality of images in certain locations on the display device 140 and/or display the plurality of images in a certain sequence or order. In another example, the display protocol 120 may include a set of computer-readable instructions that direct a computer unit to place a plurality of images on a display device 140, which may include for example, multiple screens and/or viewports. The display protocol 120 and the rules 130 may be processed in the computing device 110 through a processing unit, for example. The protocol 120 and rules 130 may be executed by the computing device 110 through an execution unit, for example. The display protocol 120 may be employed to present medical image data for a diagnostic examination of a patient anatomy.

As an illustrative example, the display protocol 120 may direct the computing device 110 and/or display device 140 to display an anterior-posterior (“AP”) image adjacent to a lateral image of the same anatomy. In another example, the display protocol 120 may direct the computing device 110 and/or display device 140 to display the AP image before displaying the lateral image. In general, the display protocol 120 may inform the attributes, spatial presentation, and/or temporal presentation of one or more images at the computing device 110 and/or display device 140.

As discussed, the display protocol 120 includes rules 130 (“rules”). A user may be able to add, delete, edit, or otherwise configure the rules 130. A rule 130 may have one or more associated conditions. A condition may be configured to evaluate one or more criteria associated with a system or user defined function that prepares and/or verifies the run-time state of medical image and non-image data, system configuration, user interfaces or interfaces to external software, system or devices, for example.

A condition may include function(s) and argument(s). An argument may be a variable or a type of variable. Some argument data types include: Boolean, integer, float, text string, enumerated code values (for example, such values may be selected from a list to reduce typographical errors), variable, and variable list, for example. Much like computer programming or mathematics, arguments are generally passed to a function, where the argument(s) are evaluated. Generally, a function may be a directive for the protocol (or processor) to evaluate various aspects corresponding to imaging data and/or other run-time information, such as: clinician identity, clinician preferences, patient, patient history, imaging modality, body part, condition, date, time, and/or the like. The function may evaluate the argument(s) against one or more criteria, for example.

The rule may employ Boolean logic, such as Boolean operators, and/or expressions. For example, the function may evaluate one or more arguments according to one or more Boolean expressions. As another example, the argument(s) may be of a type that passes Boolean expression information to the function. As an output, the function may return a result that indicates whether the Boolean expression is true or false.

Generally, a Boolean expression may employ one or more Boolean operators to compare a return value of a condition function against a criterion and returns a Boolean value true or false. A Boolean operator may be a relational or equality operator used in a Boolean expression to compare the return value of a condition function against a criterion. Some examples of Boolean operators include: AND, OR, XOR, NAND, less than, less than or equal, greater than, greater than or equal, equal, not equal, contain, contained by, and contain any, for example.

Generally, the conditions enable the display protocol to be dynamically sequenced—e.g., the execution of the display protocol may vary based on the satisfaction (or non-satisfaction) of one or more conditions. For example, the satisfaction (or non-satisfaction) of a condition may cause a rule 130 to be included, excluded, or modified during the execution of the display protocol 120. As another example, the satisfaction (or non-satisfaction) of a condition may cause the display protocol 120 to start, stop, or pause. A user may be able to add, delete, edit, or otherwise configure the conditions associated with a rule 130.

Of the various classes of conditions, two such classes are entry conditions and exit conditions. An entry condition may specify the circumstances for executing the associated rule. For example, if the entry condition is satisfied, the associated rule may be processed. Conversely, if the entry condition is not satisfied, the associated rule may be skipped. There may be two or more entry conditions, for example. For example, entry conditions may be ordered list of Boolean expressions. As an example, a given condition may be simple a Boolean expression with one condition function and one criterion, or may be a complex Boolean expression that combines two or more simple Boolean expressions. The entry conditions in a list may be evaluated in a specified order. For example, if one of the entry conditions is false, the remaining conditions in the list may not be evaluated, and the display protocol may switch to the next rule. As another example, if all entry conditions are true, the current rule may be executed.

An exit condition may specify the circumstances for switching to a subsequent rule. For example, if the exit condition is satisfied, the subsequent rule may be processed. Conversely, if the exit condition is not satisfied, the execution of the display protocol 120 may be halted, or the sequence or branching to subsequent rules may be altered. There may be two or more exit conditions, for example. For example, exit conditions may be ordered list of Boolean expressions. As an example, a given exit condition may be simple a Boolean expression with one condition function and one criterion, or may be a complex Boolean expression that combines two or more simple Boolean expressions. The exit conditions in a list may be evaluated in a specified order, and the display protocol may branch accordingly based on the evaluation of the exit condition(s).

A user may be capable of requesting a “next step” of the display protocol from an input device. Under such a request, for example, it may be useful for the protocol to (re-)evaluate exit conditions from the beginning of a list, because an exit condition previously failed may affect other exit conditions, and/or display protocol sequence(s).

Some condition functions, such as getting user input or starting an external software interface, may not need to be evaluated for each “next step” event. Under such circumstances, the system may allow a user to set the evaluation frequency when adding a condition function into a rule. The following are some evaluation frequency options: once per execution of the display protocol; once per execution of the rule in display protocol; or once per each “next step” event, for example.

The following are a few examples of conditions: determine if the number of images in the current study is less than or equal to 1200; determine if the images in the current study are grouped according to a group option; determine if the images in the current study are ordered according to an ordering option; determine if the initial zoom option is set to 2.0×; determine if a particular tool is actively selected; determine whether an alert should be displayed; determine whether an external alert should be sent to an external device; request user input for modality information; and request user input for series information.

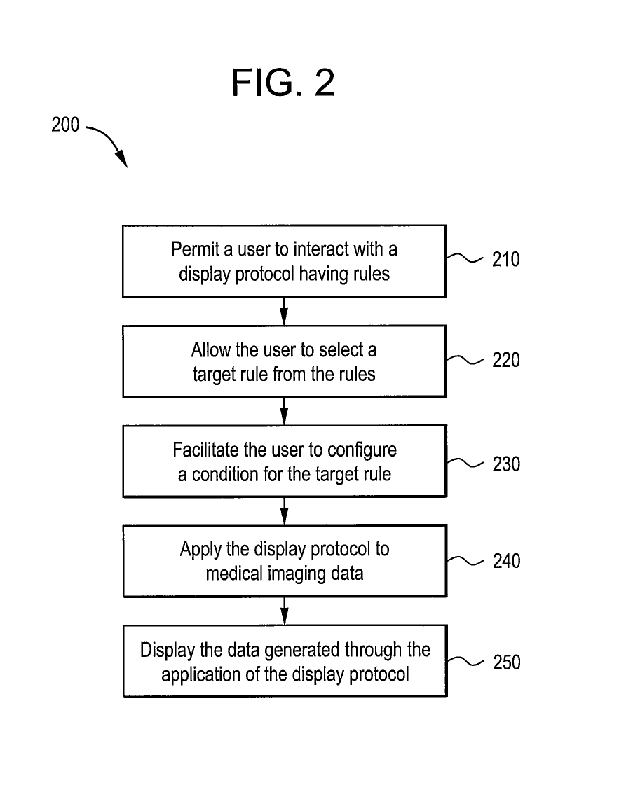

Turning to FIG. 2, a flowchart 200 for a method of processing medical image data is shown, in accordance with embodiments of the present invention. The steps of flowchart 200 may be performable, for example, by a PACS system. For example, flowchart 200 may be performable by a system such as imaging system 100, or a portion thereof. Furthermore, the steps of flowchart 200 may be performable in a different order, or some steps may be omitted. For example, step 250 may be omitted. As another example, steps may be performed in a different order according to design and/or clinical preferences. Flowchart 200, or a portion thereof, may be performable by one or more processing units. Flowchart 200, or a portion thereof, may be performable by software, hardware, and/or firmware. Flowchart 200, or a portion thereof, may also be expressible through a set of instructions stored on one of more computer-readable storage media, such as RAM, ROM, EPROM, EEPROM, optical disk, magnetic disk, magnetic tape, and/or the like.

At step 210, the user is permitted to interact with a display protocol having rules. The display protocol may have a sequence of rules, and may be adapted to inform the display of medical image data, or non-image data, to a user such as a radiologist. The rules may be configurable by the end user, or by other users. The rules may be default rules. The user may be permitted to interact through a graphical user interface (“GUI”) or other interface types—e.g., text.

At step 220, the user is allowed to select a target rule from the display protocol rules. The target rule has one or more associated conditions which may be configured by the user. At step 230, the user is facilitated to configure the condition(s) of the target rule. The user may add, delete, edit, or otherwise configure the condition(s) through a GUI or other type of interface. As discussed above, the condition(s) may evaluate one or more criteria. Based on the criteria, the display protocol may dynamically execute, according to whether the condition(s) are satisfied or not.

At step 240, the display protocol is applied to the medical imaging data, and at step 250, data is displayed through the application of the display protocol. The data displayed may also include associated non-image data, and the display of the non-image data may also be informed by the application of the display protocol.

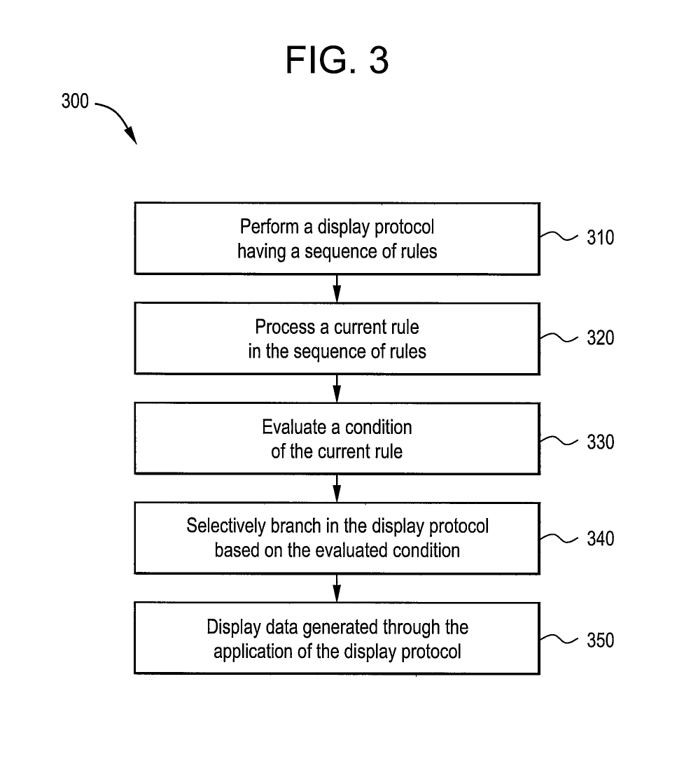

Turning to FIG. 3, a flowchart 300 for a method of processing medical image data is shown, in accordance with embodiments of the present invention. The steps of flowchart 300 may be performable, for example, by a PACS system. For example, flowchart 300 may be performable by a system such as imaging system 100, or a portion thereof. Furthermore, the steps of flowchart 300 may be performable in a different order, or some steps may be omitted. For example, step 350 may be omitted. As another example, steps may be performed in a different order according to design and/or clinical preferences. Flowchart 300, or a portion thereof, may be performable by one or more processing units. Flowchart 300, or a portion thereof, may be performable by software, hardware, and/or firmware. Flowchart 300, or a portion thereof, may also be expressible through a set of instructions stored on one of more computer-readable storage media, such as RAM, ROM, EPROM, EEPROM, optical disk, magnetic disk, magnetic tape, and/or the like.

At step 310, a display protocol having a sequence of rules is performed. The display protocol may have a sequence of rules, and may be adapted to inform the display of medical image data, or non-image data, to a user such as a radiologist. The rules may be configurable by the end user, or by other users. The rules may be default rules. The user may be permitted to interact through a graphical user interface (“GUI”) or other interface types—e.g., text. At step 320, the current rule in the sequence of rules is processed. The current rule may be the rule queued to be processed next.

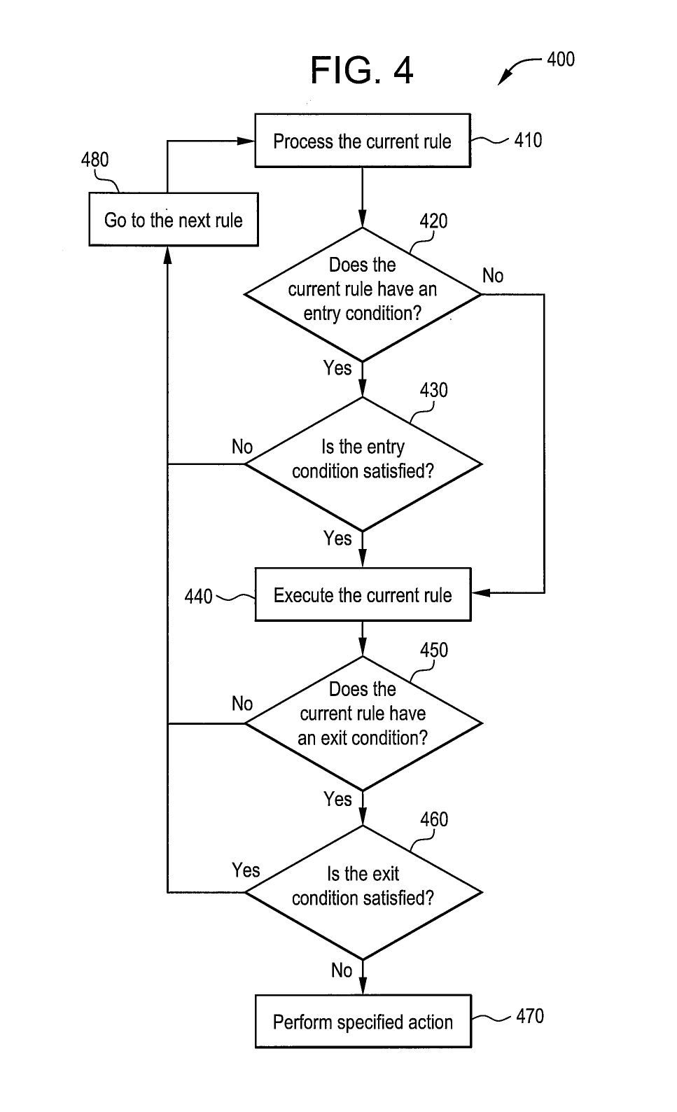

At step 330, one or more condition(s) of the current rule are evaluated. As discussed above, the condition(s) may evaluate one or more criteria. At step 340, the display protocol selectively branches based on the evaluated condition(s). Such selective branching may lead to dynamic execution of the sequence of rules, and is explained further below in association with FIG. 4. At step 350, data generated through the application of the display protocol is displayed.

Turning to FIG. 4, a flowchart 400 for a method of processing medical image data is shown, in accordance with embodiments of the present invention. The flowchart 400 shows an example of how dynamic sequencing of the rules in a display protocol may be accomplished. Certain branching paths are shown in flowchart 400, but others are possible. Further, a user may configure branching options to influence the dynamic execution of the display protocol. The steps of flowchart 400 may be performable, for example, by a PACS system. For example, flowchart 400 may be performable by a system such as imaging system 100, or a portion thereof. Furthermore, the steps of flowchart 400 may be performable in a different order, or some steps may be omitted. As another example, steps may be performed in a different order according to design and/or clinical preferences. Flowchart 400, or a portion thereof, may be performable by one or more processing units. Flowchart 400, or a portion thereof, may be performable by software, hardware, and/or firmware. Flowchart 400, or a portion thereof, may also be expressible through a set of instructions stored on one of more computer-readable storage media, such as RAM, ROM, EPROM, EEPROM, optical disk, magnetic disk, magnetic tape, and/or the like.

At step 410, the current rule is processed. At step 420, it is determined whether the current rule has an associated entry condition. If there is no associated entry condition, the current rule is executed at step 440. Other options are possible if there is no entry condition, such as halting the execution of the display protocol, executing a modified version of the current rule, skipping to another rule in the sequence (e.g., skip forward or backward to another rule besides the next rule) or otherwise dynamically modifying the execution of the display protocol. If there is an associated entry condition, the flowchart proceeds to step 430, where it is determined whether the entry condition is satisfied.

If the entry condition is not satisfied, then the flowchart goes to step 480 where the next step in the sequence is queued for processing. Other options are possible upon non-satisfaction of the entry condition, such as halting the execution of the display protocol, executing a modified version of the current rule, skipping to another rule in the sequence (e.g., skip forward or backward to another rule besides the next rule) or otherwise dynamically modifying the execution of the display protocol. If the entry condition is satisfied, then the current rule is executed at step 440.

At step 450, it is determined whether the current rule has an associated exit condition. If there is no associated exit condition, the next rule is queued for processing at step 480. Other options are possible if there is no exit condition, such as halting the execution of the display protocol, skipping to another rule in the sequence (e.g., skip forward or backward to another rule besides the next rule) or otherwise dynamically modifying the execution of the display protocol. If there is an associated exit condition, the flowchart proceeds to step 460, where it is determined whether the exit condition is satisfied.

If the exit condition is satisfied, then the flowchart goes to step 480 where the next step in the sequence is queued for processing. Other options are possible upon satisfaction of the exit condition, such as halting the execution of the display protocol, skipping to another rule in the sequence (e.g., skip forward or backward to another rule besides the next rule), or otherwise dynamically modifying the execution of the display protocol. If the exit condition is not satisfied, then a specified action is performed at step 470. For example, the execution of the sequencing of rules may be halted, or paused. As an example, the protocol may be paused, and may resume sequencing upon further interaction from the user. Other options are possible if there is no exit and/or entry condition, such as executing a modified version of the current rule, skipping to another rule in the sequence (e.g., skip forward or backward to another rule) or otherwise dynamically modifying the execution of the display protocol.

The following is an example of a user defined dynamic display protocol sequence for mammography studies of a given patient. The display protocol includes three rules. Rule #1 causes the display of four historical views of medical image data for the patient on the left monitors of the display device and four current views of medical image data for the patient on the right monitor of the display device. Rule #2 causes the display of two current cranio-caudal (“CC”) views of medical image data for the patient on the left monitors of the display device and medio-lateral oblique (“MLO”) views of medical image data for the patient on the right monitor of the display device. Rule #3 causes the display of a current right cranio-caudial (“RCC”) view of medical image data for the patient on the left monitors of the display device and a current left cranio-caudial (“LCC”) view of medical image data for the patient on the right monitor of the display device.

Rule #1 has an associated entry condition and exit condition. For the entry condition, if the number of historical exams for a the patient is greater than, or equal to 1, then the entry condition of Rule #1 is satisfied. For the exit condition, if a partial view is shown, then the exit condition of Rule #1 is satisfied.

Rule #2 has an associated entry condition and exit condition. For the entry condition, if the number of historical exams for a given patient is equal to 0, then the entry condition of Rule #2 is satisfied. For the exit condition, if a partial view is shown, then the exit condition of Rule #2 is satisfied.

Rule #3 has two associated entry conditions and two exit conditions. The two entry conditions may also be considered a single condition with two criteria. The two exit conditions may also be considered a single condition with two criteria. For the entry condition, if there is current RCC data, or there is current LCC data, then the entry condition of Rule #3 is satisfied. For the exit condition, if a computer-aided diagnosis (“CAD”) is shown, or if a partial view is shown then the exit condition of Rule #3 is satisfied.

In this example, the Rule #1 will be skipped when there is no historical exam for the patient. Rule #2 will be skipped when there is at least one historical exam for the patient. Rule #3 will display the CAD results and all partial view images for RCC and LCC before switching the next rule in the sequence.

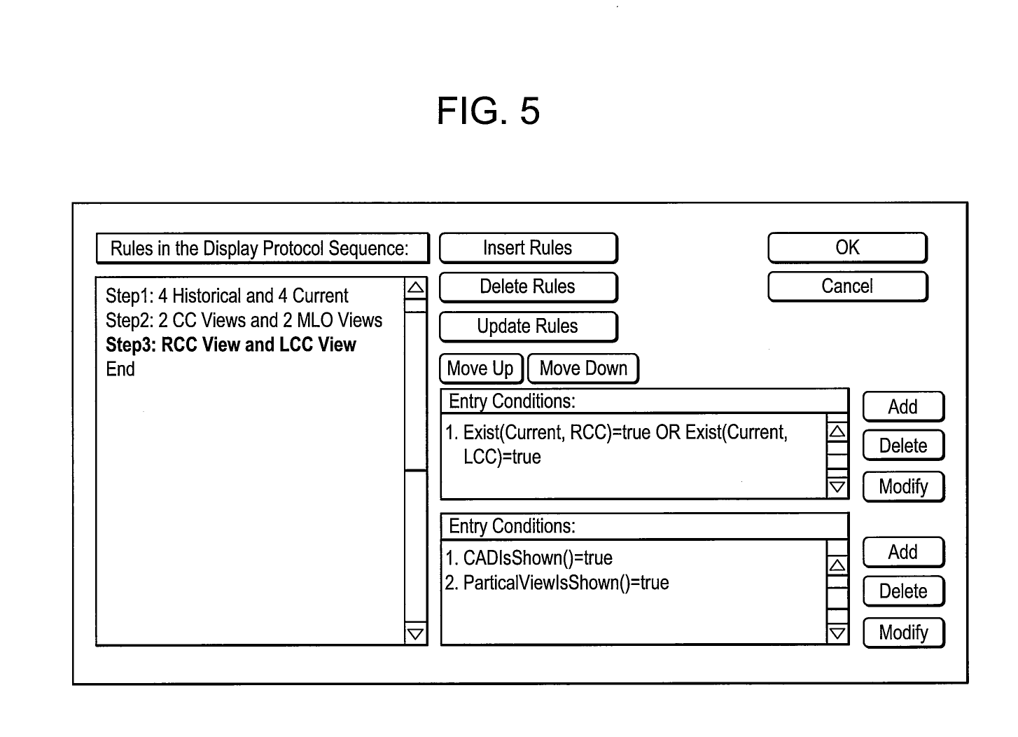

Turning to FIGS. 5, 6, and 7, sample screen shots corresponding to embodiments of the present invention are depicted. The screen shots are examples only, provided for illustrative purposes. In FIG. 5, a screen shot is depicted that allows a user to interactively configure rules for a display protocol. The user is capable of inserting, deleting, and updating rules (displayed in the left field—Steps 1-3). For each rule, the user is further able to add, delete, or modify the entry condition(s) and/or exit condition(s).

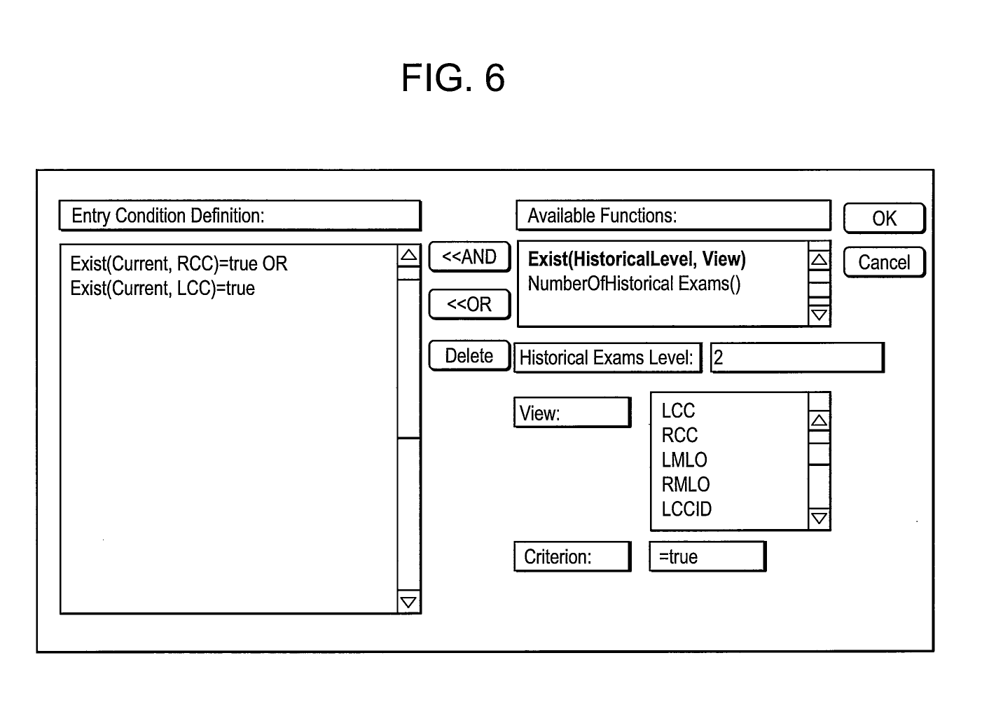

Further shown in FIG. 6, a user may be able to configure the functions and/or arguments associated with a given condition. For example, a user may be able to choose from available functions and add them to a list of functions that will be evaluated for a given condition. The user can add the functions according to Boolean logic, by using AND, and/or OR operations. For a given function, the user may be able to select arguments and/or criteria, for example. The available arguments and/or criteria may vary according to a particular function, for example.

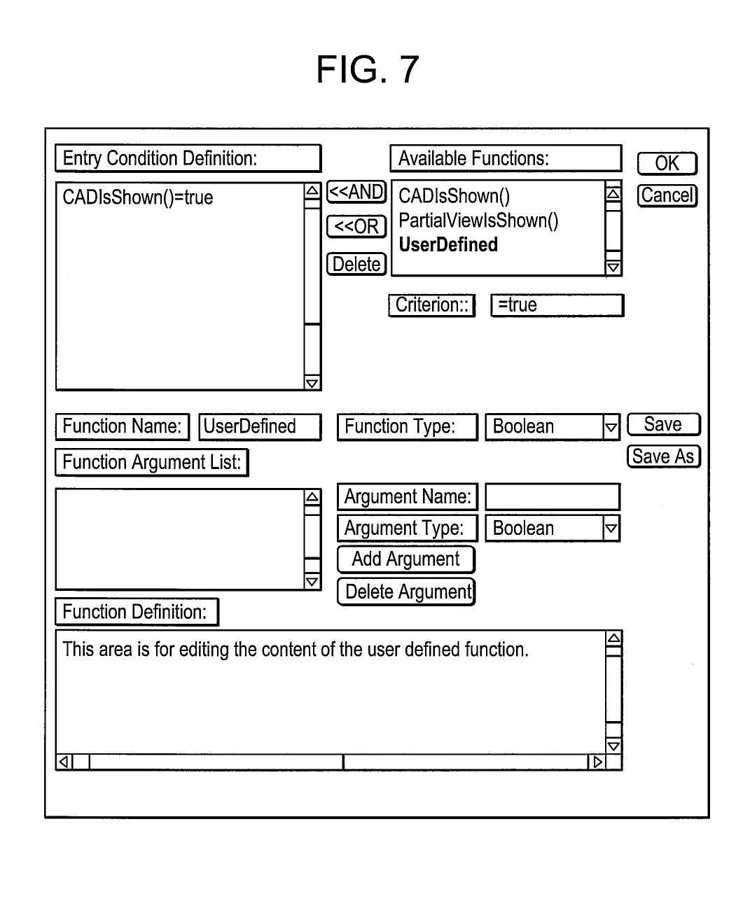

As further shown in FIG. 7, a user may be provided the ability to configure a user defined function. The top half of FIG. 7 is similar to FIG. 6. The bottom half of FIG. 7 is an example interface showing how a user may configure a user defined function. The user may be able to select the name, and type of the function. The user may further be able to configure argument(s) by specifying the name and type of argument.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for configuring a medical imaging system, the method comprising:
permitting a user to interact with a display protocol, said display protocol further comprising a plurality of rules;
allowing said user to select a target rule from said plurality of rules; and
facilitating said user to configure a condition for said target rule,
wherein said display protocol is capable of a first execution when said condition is satisfied, and wherein the display protocol is capable of a second execution when said condition is not satisfied.

2. The method of claim 1, wherein said condition further comprises at least one of: an entry condition and an exit condition.

3. The method of claim 1, wherein said condition is capable of being satisfied by a triggering event.

4. The method of claim 1, wherein said user is facilitated to configure said condition using a graphical user interface on a PACS workstation.

5. The method of claim 1, wherein said target rule comprises at least one Boolean expression.

6. The method of claim 1, wherein image data is displayed through the application of said display protocol.

7. The method of claim 1, wherein non-image data is displayed through the application of said display protocol.

8. A method for medical imaging, the method comprising:
performing a display protocol, said display protocol further comprising a sequence of rules;
processing a current rule in said sequence of rules;
evaluating a condition of said current rule; and
selectively branching in said display protocol based on said condition.

9. The method of claim 8 further comprising displaying image data, wherein a view of said image data is generated through the application of said display protocol.

10. The method of claim 8 further comprising displaying non-image data through the application of said display protocol.

11. The method of claim 8, wherein said condition further comprises at least one of: an entry condition and an exit condition.

12. The method of claim 8, wherein the evaluation of said condition is based on a triggering event.

13. The method of claim 8, wherein said target rule comprises at least one Boolean expression.

14. A management system for display protocols in a picture archiving and communication environment, the system comprising:
an electronically stored display protocol, said display protocol further comprising a sequence of rules;
a processing unit for processing a current rule in said sequence of rules, and for evaluating a condition of said current rule; and
an execution unit for selectively executing at least one rule in said display protocol based on said condition.

15. The system of claim 14, wherein said condition further comprises at least one of: an entry condition and an exit condition.

16. The system of claim 14, further comprising a display device for displaying image data through the application of said display protocol.

17. The system of claim 14, further comprising a display device for displaying non-image data through the application of said display protocol.

18. A computer readable storage medium including a set of instructions for a computer, the set of instructions comprising:
a processing routine for processing a display protocol, said display protocol comprising a current rule in a sequence of rules;
an evaluation routine for evaluating a condition of said current rule; and
an execution routine for selectively executing at least one rule in said display protocol based on said condition.

19. The set of instructions of claim 18 further comprising a display routine for displaying through the application of said display protocol, at least one of: image data and non-image data.

20. The set of instructions of claim 18, wherein said condition further comprises at least one of: an entry condition and an exit condition.
